(19) United States
(12) Patent Application Publication
(10) Pub. No.: US 2011/0120416 A1
(43) Pub. Date: May 26, 2011

(54) MULTI-FUEL DIESEL INTERNAL COMBUSTION ENGINE

(75) Inventors: Matthias Lamping, Friesoythe (DE); Andreas Kolbeck, Herzogenrath (DE)

(73) Assignee: FEV MOTORENTECHNIK GMBH, Aachen (DE)

(21) Appl. No.: 12/947,143

(22) Filed: Nov. 16, 2010

(30) Foreign Application Priority Data
Nov. 26, 2009 (DE) DE 10 2009 055 73

(51) Int. Cl. F02M 69/04; F02B 13/00; F23Q 7/00; F01L 1/34; F02B 75/04; H01T 13/08

(52) U.S. Cl. 123/445; 123/575; 123/145 R; 123/90.15; 123/48 R; 123/169 R

(57) ABSTRACT

A diesel internal combustion engine that is operated advantageously at least predominantly according to the diesel principle, with a multi-fuel adaptation unit that reacts to various fuels of different mixtures and adapts an operating mode of the internal combustion engine to these fuels, wherein the multi-fuel adaptation unit comprises at least the following elements:
a fuel characterization,
a combustion-chamber filling that can be adapted as a function of a characteristic fuel,
external ignition that can be allocated to each cylinder of the internal combustion engine,
at least one control device that implements a first control strategy in which, in a lower load range, external ignition is performed, and a second control strategy in which automatic ignition is performed in a load range that is higher relative to the lower load range,
a combustion-point control that can be adapted automatically to the characterized fuel, and
a conversion-rate control that can be adapted automatically to the characterized fuel.

### CROSS-REFERENCE TO RELATED APPLICATIONS

This application claims priority of German Patent Application DE 10 2009 055 734.2 filed Nov. 26, 2009, the contents of which are incorporated herein by reference.

### FIELD OF THE INVENTION

The present invention relates to a diesel internal combustion engine that is preferably operated at least predominantly according to the diesel principle with automatic ignition, but can also be operated by means of external ignition and/or with ignition support, such as a glow device.

### BACKGROUND OF THE INVENTION

Due to the problems of global climate change and demands for strong reductions in CO₂ emissions, the desire is growing to be able to replace at least a portion of the fossil fuels based on crude oil by a renewable component. However, it is not yet completely clear what strategy for replacement will be or can be pursued. According to a first approach, it appears useful to provide at least partial replacement of a diesel fuel. Thus there is a first demand for reliable engine operation with various diesel-like fuel mixtures.

Furthermore, today the percentage of diesel fuel that is consumed in road traffic is already significantly higher, at least in Europe, than that of gasoline. In all likelihood, this will also not change in the future. One consequence is that diesel and gasoline fuel is shifted between regions with different percentages of spark-ignition and diesel engines, in order to keep the efficiency of the production process high in the refinery. A significantly larger percentage of diesel vehicles in other markets would significantly limit such a practice and would lead to large losses in efficiency and thus to higher CO₂ emissions in the production process if the system is viewed overall.

As a result, it follows that gasoline-diesel mixtures that are burned in the automatic ignition method could shift these points.

In addition, in other markets, such as China, India, U.S.A. and also Russia, there are, in parts, greatly varying fuel qualities. In the U.S.A., a market in which more and more vehicles with modern diesel engines have been offered in recent years, the fuel qualities and properties vary greatly even within individual states.

Consequently, an internal combustion engine must be in the position to burn these different fuels cleanly with the highest possible efficiency. If one assumes that the fuel supply is differentiated even further, because different sources of fossil and renewable fuels must be used to maintain passenger and freight transport, these demands are increased even further.

The objective of the present invention is therefore to provide an internal combustion engine and an operating mode of an internal combustion engine with which different fuels can be converted robustly and with the highest efficiency while observing current exhaust-gas limits.

### SUMMARY OF THE INVENTION

This objective is obtained with an internal combustion engine and also with an operating mode of an internal combustion engine as described in the claims. Other advantageous constructions and refinements follow from the dependent claims. Each of the resulting features, however, is not limited to the individual constructions, but instead could be linked with other features from the general description and also from the description of the figures to form refinements.

A diesel internal combustion engine is proposed that is preferably operated at least predominantly according to the diesel principle. The internal combustion engine has a multi-fuel adaptation that reacts to different mixtures of various fuels and adapts the operating mode of the internal combustion engine to these mixtures, wherein the multi-fuel adaptation comprises at least the following elements: a fuel characterization, a combustion-chamber filling that can be adapted as a function of a characterized fuel, external ignition allocated to each cylinder of the internal combustion engine, at least one control device that implements a first control strategy in which external ignition is performed in a lower load range and a second control strategy in which automatic ignition is performed in a load range that is higher relative to the lower load range, a combustion-point control that can be adapted automatically to the characterized fuel, and a conversion-rate control that can be adapted automatically to the characterized fuel.

By means of linking all of the measures that do belong to the prior art individually, but not as a whole, it is possible to use very different fuels in a stable manner across all of the operating ranges.

Such an internal combustion engine can be used, for example, preferably in motor vehicles for road traffic, as well as for commercial vehicles, in which transient operating phases occur during city traffic as well as load-stable operating phases on highways, but also for industrial motor applications, for example, in the case of stationary installations. These could be emergency power supplies, but also combined heat and power plants or other power-generating plants. In particular, it is possible that, in addition to conventional fuels currently available for sale on the road, fuels with lower cetane numbers, as well as boiling curves with boiling points deviating from conventional diesel fuels, could be used. Preferably, very different fuels can be used alone or in mixtures with each other. In particular, with such an internal combustion engine, long ignition delays can be compensated so that such fuel mixtures feature automatic ignition in wide ranges of an operating characteristic map of the internal combustion engine. According to one construction, it is provided that a variable compression ratio is provided. By means of variable valve timing, there is the ability to provide different lifts in different ranges. According to one construction it is provided, for example, that in the lower load range, the compression ratio is increased, while in an upper load range, the compression ratio is lowered. This can be a component, for example, of the first or second control strategy. With respect to the effect of the use on different, previously known fuels, refer to, e.g., the SAE paper “Tomorrow's Diesel Fuel Diversity—Challenges and Solutions,” Lamping, Körfer et al., 08SFL-0047. That publication examines the properties of various fuels and their influence on the operating behavior of an internal combustion engine. That publication also proposes a control strategy for how the internal combustion engine could be operated according to the different properties of each fuel by adapting the pre-injection and primary injection accordingly. In this way it is possible within certain limits to cause an ignition-averse fuel to ignite at the proper time, so that automatic ignition is made possible within very different operating ranges. In the scope of the invention, that publication is incorporated in this respect in its full extent through this reference. In addition, here it is now also proposed that, by means of a variable valve train, an adaptation of the combustion-chamber filling, and a swept volume adaptation by means of the characterization of the fuel advantageously not only at the beginning of a startup of the internal combustion engine, but also during the operation, the fact is taken into account that when the gas tank is filled up with different fuels, the same fuel is not always available. Thus, with the proposed internal combustion engine, gasoline fuels with, for example, ROZ 91 to ROZ 98, as well as diesel fuels, but also mixtures of these fuels can be converted.

According to one construction, the fuel characterization has, e.g., a fuel sensor by means of which a characteristic of the fuel can be detected. This can be performed, for example, by means of an analysis of the fuel. Another construction provides that a detection of a characteristic is performed by means of an ignition delay dwell time. For example, a transducer is provided that acts in this configuration as a fuel sensor. In a test ignition, the characteristics of a fuel can be determined by means of combustion misfiring and delay time. For example, the ignition delay time is determined by means of a cylinder pressure sensor and a calculation of the combustion. Preferably, this is performed in a cylinder-selective way. For example, for this purpose each cylinder has a cylinder pressure sensor. This can be provided, for example, integrated into an ignition device, in particular, a spark plug. If a threshold of the permitted ignition delay is exceeded, for example, the cylinder filling is changed with the accompanying change and especially shortening of the ignition delay time. Likewise, there is thus also the possibility to extend the ignition delay time, for example, if this has an advantageous effect on the emissions. A change could also be performed independent of a threshold. For this purpose, a control strategy could have different implementations. By means of the combustion-point regulation, another fine adjustment can then be performed in the scope of the control concept. Another construction provides that the characterization of the fuel is performed in the form of identification. For example, the internal combustion engine has, e.g., a control device and a database in which various fuels and properties are stored. This database can be loaded with data that is, for example, dependent on region. In this way, the complexity of the characterization step can be simplified, because, e.g., a sufficient property characterization for the fuel can be performed by a small number of measurements, preferably by means of only one single measurement, and the fuel can be identified again with reference to the data stored in the database. Furthermore, there is the possibility that, in addition to automation of this fuel identification by the fuel characterization, an external input of the fuel characterization is also possible. Thus, for example, through the fuel-filling process, there is the possibility that, during the fuel-filling process, information is transmitted from the gas station to the vehicle and, in particular, to a control device of the internal combustion engine, from which the characterization of the fuel can be inferred.

Combustion point regulation can be performed in various ways. For example, from DE 197 498 17 A1 it is known to determine the beginning of the fuel injection and the combustion point from a difference between a measured pressure profile and a calculated pressure profile. In addition, it is known, for example, from WO 2005/005813 A2 to set the beginning of the fuel injection and/or the inert-gas component in the combustion chamber from a state variable allocated to a combustion chamber. Furthermore, from WO 2005/005813 A2, a regulation of a fuel injection device is known in which, under the use of a combustion point regulator, the beginning and the duration of the fuel injection are set according to the combustion chamber under consideration of the last working cycle. Another construction of a combustion point regulation follows, in turn, from the publication-pending PCT/EP2008/004175 of the applicant. In the scope of the disclosure, the above publications are incorporated in their full content with respect to combustion point regulation, but also their corresponding components, through this reference.

The conversion-rate regulation can be performed, in turn, likewise in different ways. A first conversion-rate regulation follows, for example, from DE 10 2007 013 119 A1, and another, second conversion-rate regulation from DE 10 2006 015 503 A1. In the scope of the disclosure of the invention, the content of these two publications is likewise incorporated in this respect in their full extent through this reference.

The adaptable combustion-chamber filling that is performed as a function of the characterized fuel is preferably determined essentially by a control device, in particular, the control device responsible for the injection. Here, combustion-chamber filling means the targeted filling of the combustion chamber with air, fuel, but also exhaust gas, for example, through targeted internal and/or external exhaust-gas recirculation. These can be tuned, in particular, to each other. Also, the combustion-chamber filling can provide how the filling is performed, for example, through the appropriate setting of flow paths, for example, for generating a swirl and/or a different flow behavior. The combustion-chamber filling can here be adapted in different ways. For example, in addition to single and multiple injection, pilot injection, secondary injection, installment injection, continuous or variable injection, even a change with respect to the exhaust-gas recirculation is also possible. Exhaust-gas recirculation can be performed, for example, as internal exhaust-gas recirculation through corresponding switching of the valve train allocated to a cylinder, in that the valves are switched so that they allow recirculation of already combusted exhaust gas from the exhaust-gas apparatus back into the combustion chamber. External exhaust-gas recirculation can be performed, for example, by means of a bypass, wherein a return flow via this bypass is at least controlled, but preferably regulated by an exhaust-gas recirculation valve. In addition, the air filling can likewise be adapted to the characteristics of the fuel by corresponding activation of the inlet or outlet valves. Therefore, it is preferred that a variable valve train is provided at least on the outlet side, but preferably also on the inlet side, at least for each valve, preferably for all valves of a cylinder. The variable valve train can be performed, for example, by means of a cam adjustment, a camshaft adjustment, through mechanical, hydraulic, or other valve-activation mechanisms, such as, for example, electromechanical or electromagnetic valve trains.

One refinement provides that, in addition to a variable combustion-chamber filling, the compression ratio can also be set variably as a function of the characterized fuel. By means of a variable compression ratio, for example, in a lower load range, the compression ratio is set to at least 18 according to the fuel property. In this way it is possible to raise a temperature of the cylinder filling and thus to achieve reliable automatic ignition. In addition, there is the possibility to likewise raise a temperature of the cylinder filling by means of a variable valve train and an inner exhaust-gas recirculation. In particular, the variable valve train, as well as the inner exhaust-gas recirculation, is used, in addition to raising the compression ratio in the lower load range, to be able to stabilize automatic ignition and also to simultaneously allow a reduction of the HC and CO emissions. In particular, the operating mode is possible exclusively according to the diesel principle. In this way, the internal combustion engine can be used as a pure diesel internal combustion engine for an appropriate fuel quality. In contrast, if a fuel mixture is supplied, e.g., a fuel with cetane numbers above 40 as well as boiling points of above 150° C. for the evaporation of the 10 vol % of the fuel and boiling points above 200° C. for the evaporation of 90 vol % of the fuel or fuel mixture, this diesel operation could also be maintained. However, if a fuel of the fuel mixture is selected so that, overall, the fuel mixture has a cetane number that is <40 and, in particular, <30 and, for example, moves in a cetane number range between 10-25, wherein the corresponding boiling points of the fuel component being used are likewise changed, then this internal combustion engine is no longer operated as a pure diesel internal combustion engine in the entire characteristic map range and under all initial conditions. Instead, the reduction of the cetane number leads to an increasing ignition delay time of the fuel. However, in order to ensure combustion in the internal combustion engine with reference to the specified emissions, for example, combustion is initiated and guaranteed by means of glow, surface, or spark ignition. Thus, in addition, ignition support and/or external ignition can be provided. External ignition can provide, for example, a protected glow plug, for example, with a sleeve body having penetration points, a glow plug with high-strength material, or a gasoline-like spark plug alone or in addition to the glow plug. In addition, reliable ignition can be supported by means of the alignment of one or more fuel jets relative to the ignition device.

For example, in one construction, in the case of a reduced cetane number in an upper load range in which a temperature of the cylinder filling is sufficient for automatic ignition, combustion is maintained according to the diesel-engine principle. In a lower load range in which, however, automatic ignition is no longer guaranteed, because it is performed not at all or only stochastically due to the low cetane number, combustion by means of ignition support is guaranteed. For example, a glow plug and/or spark plug is allocated to each cylinder, in order to be able to guarantee operation according to the first control strategy. Here it is likewise provided that the internal combustion engine is operated at different operating points due to the fuel characterization. For this purpose, the control device has different control strategies. For example, a startup of the internal combustion engine can be performed by automatic ignition but also by external ignition. Here, a control strategy can decide the state of the internal combustion engine and how the fuel characterization affects this state. For example, if the surroundings of the internal combustion engine are such that there are low temperatures and the internal combustion engine is cooled itself, but on the other hand the cetane number according to the fuel characterization is very low, external ignition can be specified by means of the control device in a startup mode of the internal combustion engine. For example, if the internal combustion engine is in an operating state that is to be characterized as warm and the cetane number according to the fuel characterization is such that the ignition capacity is sufficient, a startup mode can be performed by automatic ignition. If, for example, a start-stop mode is performed as is typical in city traffic, in this start-stop mode, a change can also be performed between automatic ignition and external ignition, especially as a function of the characterization of the fuel and preferably also under inclusion of a state identification with reference to the operating state of the internal combustion engine.

For example, it is provided according to one refinement that the first and second control strategies are stored together in one control algorithm. The control algorithm itself is constructed, in turn, so that, for example, as a function of, e.g., the characteristic of the fuel and also the operating parameter of the internal combustion engine, a changeover from automatic ignition to external ignition and vice versa is performed. Here it is provided that the internal combustion engine is operated predominantly according to the diesel principle, and the changeover between external and automatic ignition is performed only if the cetane number or the characteristics of the fuel permits nothing else, for example, under consideration, on one hand, of emissions, combustion noise, and/or combustion stability, and on the other hand, on the fuel to be used itself and thus the efficiency.

In addition, it is provided that the automatically adaptable combustion point regulation is in the position to observe emission limits in each of the existing regions. For this purpose, it can be provided, for example, that the internal combustion engine has, in particular also contains, a corresponding exhaust-gas regulation stored in at least one or more control devices to be designed with reference to current emission regulations.

A combustion-chamber filling can be performed, for example, as described in DE 102 005 007 057 of the applicant. The description contained therein and also the procedure and the figures therein are incorporated completely in connection with this invention through this reference, as well as the prior art named there. A cylinder pressure profile control that is likewise addressed in the proposed internal combustion engine or the proposed operating mode follows, for example, from DE 10 2007 012 604 of the applicant. This is similarly incorporated completely in the scope of the disclosure through this reference. A control system for controlling the exhaust-gas recirculation follows, for example, from WO 2008/131788 or WO 2008/131789, but also from DE 10 2009 016 509 of the applicant. This is likewise completely incorporated in the scope of the disclosure through this reference. A combustion point control and also a pre-control of a combustion point control follow, in turn, from PCT/EP2008/004175 of the applicant. This and also the publications named therein with respect to combustion point control are likewise incorporated completely in the scope of this disclosure through this reference. From DE 20 2004 000 300, a diesel internal combustion engine and a fuel composition for this engine follow, in turn. From DE 10 2006 015 503 A1 and from DE 102 007 013 119 A1 [sic; probably DE 10 2007 013 119 A1], methods for controlling the injection profile follow. These publications are likewise incorporated completely in the scope of the disclosure through this reference. A turbocharger control follows, for example, from DE 199 601 66. The internal combustion engine is charged, in particular, for improving the filling of the cylinder. A charging strategy is integrated, in turn, advantageously in a control, so that external ignition or automatic ignition can be performed in different operating ranges. The conversion-rate control can be based, in turn, according to another construction, for example, on a quality control in which the engine torque is used as a parameter of the control as a function of the injected fuel quantity. This can also be realized in the form of regulation. A combustion chamber of the internal combustion engine in use can be provided, for example, with an undivided combustion chamber and also with a divided combustion chamber. For example, a pre-chamber can be allocated to the actual main combustion chamber, wherein, by means of the pre-chamber, at least one part of the fuel mixture to be injected is supplied.

According to another concept of the invention, an operating mode of an internal combustion engine is proposed that is operated with a fuel mixture having first and second fuels, wherein the internal combustion engine operates at least predominantly according to the diesel principle, wherein a first control strategy performs external ignition in a lower load range and a second control strategy performs automatic ignition in a load range that is higher relative to the lower load range. Adapting to this operating mode can be provided in that, for example, the fuel mixture is characterized and a combustion point control is adapted to this characterization. Also, by means of fuel characterization, conversion control can be adapted. The cylinder filling is likewise performed as a function of the characterization of the fuel mixture. Preferably, the internal combustion engine or the operating mode of such an internal combustion engine is used for a fuel mixture that has a cetane number of below 40, preferably below 35, in particular, below 30 and advantageously up to 10 and has a boiling point in a range between 90° C. (10 vol %) and 200° C. (90 vol %).

One application example of the internal combustion engine and/or the operating mode of the internal combustion engine as described above and also with reference to the following figures provides that one or more operating modes of the internal combustion engine are geared toward the exhaust-gas aftertreatment process, preferably to a regeneration operation of an exhaust-gas aftertreatment device, in particular, a particulate filter, to a heating operation of an exhaust-gas aftertreatment device, and/or achieving an increase in the DeNOx efficiency of an exhaust-gas aftertreatment device.

One possibility of a DeNOx device is made possible by means of an SCR catalytic converter, Selective Catalytic Reduction, in which nitrogen oxides NOX are reduced with the help of ammonia NH3 to nitrogen and water vapor. As a reduction agent, urea in aqueous solution is often used. Other methods use ammonium carbamate, which significantly simplifies storage and handling. A DeNOx device could also act as an HC-SCR catalytic converter in which hydrocarbons, especially C₂-C₅ olefins, are used as the reduction agents. Furthermore, there is the possibility of using an NSR catalytic converter, a NOx storage-reduction catalytic converter. For these methods, the reduction agent for regenerating the storage reservoir is made available by engine generation during short, rich operating phases. Between the regeneration processes, the nitrogen oxides are stored in the form of nitrates in the catalytic converter.

### BRIEF DESCRIPTION OF THE DRAWINGS

Other advantageous constructions and refinements emerge from the following figures. The constructions presented there, however, are not limiting, but are merely examples. Individual or multiple features of one construction could also be separated from this construction and linked with other features of a different construction like from the above description to form refinements. Shown are:

FIG. 1 illustrates a conventional operating mode of the diesel internal combustion engine,

FIG. 2 illustrates a first operating strategy for a warm internal combustion engine,

FIG. 3 illustrates another operating strategy for a cold engine,

FIG. 4 illustrates a third operating strategy,

FIG. 5 illustrates a fourth operating strategy for a cold engine,

FIG. 6 illustrates a fifth operating strategy for a warm engine, and

FIG. 7 illustrates a simplified characterization of a fuel range.

### DETAILED DESCRIPTION OF THE INVENTION

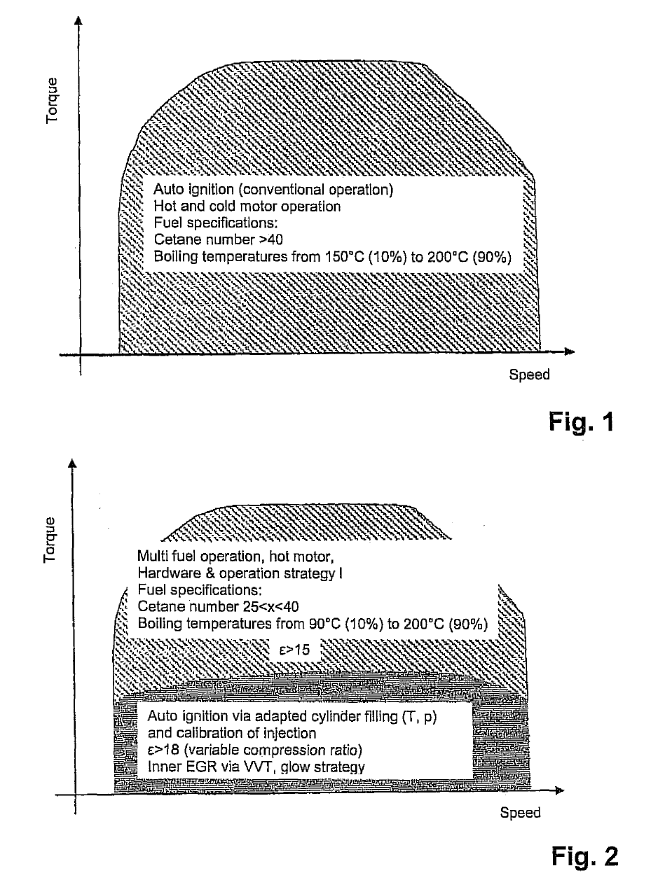

In a first construction, FIG. 1 shows an operation of the diesel internal combustion engine in the conventional automatic ignition operation. In the warm engine mode and also in the cold engine mode, only automatic ignition is performed across the entire torque-generating area. This is used especially when the fuel specification has a cetane number of >40 and the fuel has a boiling point above 150-200° C. at 10 vol % and 90 vol %, respectively. This means that the proposed diesel internal combustion engine is in the position to be used as an internal combustion engine operating only in the diesel mode. This control strategy is determined during the characterization of the fuel that is put into the gas tank.

According to one refinement, it is provided that, advantageously, a fill-level evaluation of the fuel still in the tank is stored in addition to the characterization of the fuel, for example, in a control device of the internal combustion engine. If a different fuel with different fuel characteristics is now put into the tank, the characterization of the fuel is changed automatically as a function of the filled quantity that is determined, for example, by the fill level in the tank. This can be performed, for example, in that information on the fuel is transmitted to the control device of the internal combustion engine when the tank is filled with fuel. Furthermore, there is the possibility that the internal combustion engine performs a characterization of the fuel by means of corresponding sensors of very different fuel mixtures at various times and adapts a control unit accordingly with respect to the operating mode to be used.

FIG. 2 shows an operating strategy in the case of a warm diesel internal combustion engine in an example construction. While automatic ignition is performed in a lower torque range by means of, for example, adapted cylinder filling and calibration of an injection unit, in addition, internal exhaust-gas recirculation can be used by means of a variable valve train and a glow support unit; if only, for example, stochastic automatic ignition is still set, it is also preferably provided that the compression ratio is set variably and is set, in particular, to a value of ε>18 in this range of the automatic ignition. If a higher torque is demanded, for example, the compression ratio is reduced to ε>15. Such an operating mode is performed, in particular, at a cetane number of 25-40 for the fuel mixture being used, especially when a boiling point is set between 90-200° C. at 10 vol % and vol 90% [sic; 90 vol %], respectively.

By decreasing the compression at high torques, the mixture formation is improved and a high specific power is also generated. In the automatic ignition range, the mixture is set to be hyperstoichiometric, wherein a decrease in the injection pressure can also be provided. For example, pressure regulation of the fuel can be provided such that this is controlled from 1500 bar to a range below 1000 bar, advantageously below 600 bar. For this purpose, for example, a high-pressure pump could have two stages, so that losses are minimized. There is also the possibility of being able to perform a quantity regulation for adapting the injection pressure.

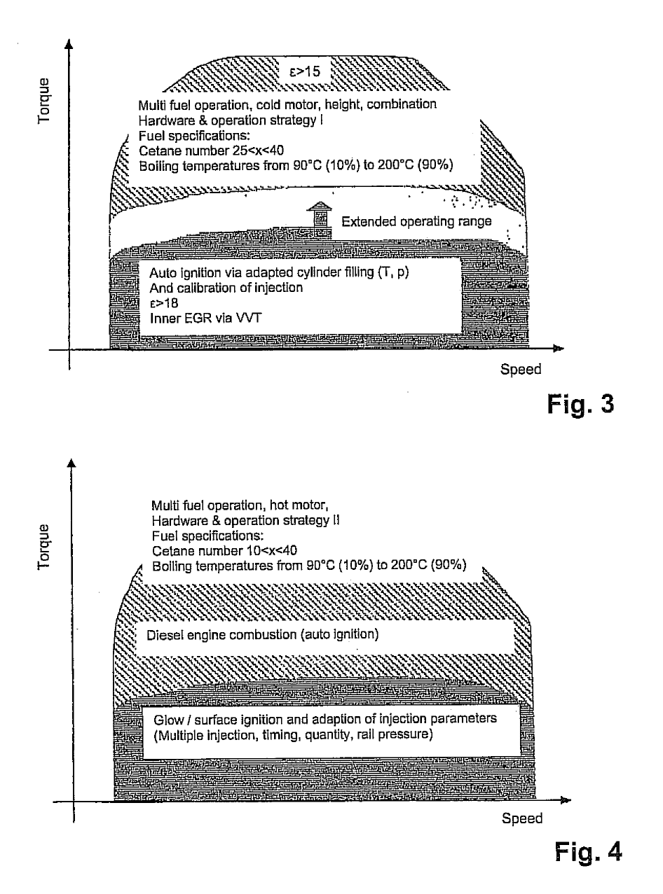

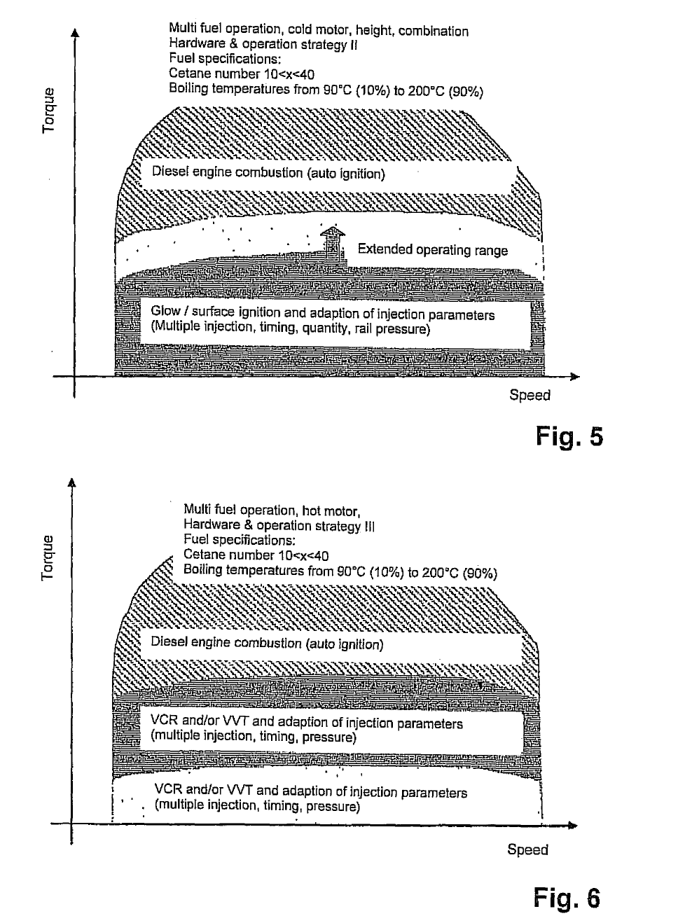

FIG. 3 shows a second operating strategy that is preferably used for cold internal combustion engines. Here, a fuel mixture is used preferably from first and second fuels with boiling points above 90° C. with 10 vol % to 200° C. at 90 vol % and a cetane number of 25-40. In the lower range, for increasing the compression ratio it comes to a value ε>18 that is decreased at a higher torque demand to a value that is ε>15. Between this automatic ignition and external ignition range, another operating range is inserted. In this expanded operating range, it is decided adaptively whether a changeover to the external ignition mode should be performed or whether automatic ignition is still performed.

FIG. 4 shows a third operating strategy for the use of a fuel in which the cetane number lies between 10 and 40. Here, a warm engine is assumed, wherein automatic ignition is provided at high torques, while glow or surface ignition is performed at lower torques. This is identified by corresponding hatching. In the case of glow or surface ignition, the injection parameters, in particular, are adapted, such as multiple injections, injection times and duration, injection quantity, and also adapted rail pressure if a common rail is used. For example, the rail pressure could be decreased if glow or surface ignition is used.

FIG. 6 shows another operating strategy that is geared to the operation of a warm diesel internal combustion engine. A fuel specification is assumed with a cetane number between 10 and 40 and a boiling point of the fuel mixture above 90° C. for 10 vol % to 200° C. at 90 vol %. In the upper torque range, diesel-motor combustion is performed by means of automatic ignition by the control unit. In a torque range lying directly underneath, the cylinder filling is adapted by means of the variable valve train or by means of an adapted stroke setting, wherein the injection parameters are likewise adapted, e.g., by multiple injections, changing the injection times, and also increasing or decreasing the injection pressure. Below this range at low torques, a glow ignition or surface ignition or else also a spark ignition is performed, wherein likewise the injection parameters named above are adapted accordingly.

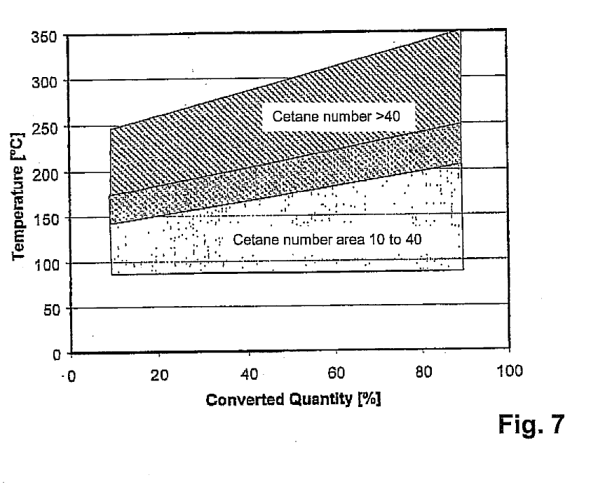

In a simplified diagram, FIG. 7 shows a boiling-point characteristic curve or characterization of a fuel range, wherein cetane numbers between 10 and 40 are arranged in a lower range, while cetane numbers >40 are produced in the upper range.

It is claimed:

1. A diesel internal combustion engine that is advantageously operated at least predominantly according to the diesel principle, with a multi-fuel adaptation that reacts to different mixtures of various fuels and adapts an operating mode of the internal combustion engine to these mixtures, wherein the multi-fuel adaptation comprises:
a fuel characterization;
a combustion-chamber filling that can be adapted as a function of a characterized fuel;
an external ignition allocated to each cylinder of the internal combustion engine;
at least one control device that implements a first control strategy in which external ignition is performed in a lower load range, and a second control strategy in which automatic ignition is performed in a load range that is higher relative to the lower load range;
a combustion-point control that can be adapted automatically to the characterized fuel; and
a conversion-rate control that can be adapted automatically to the characterized fuel.

2. The diesel internal combustion engine according to claim 1, wherein a glow plug and/or spark plug is allocated to each cylinder.

3. The diesel internal combustion engine according to claim 1, wherein a variable valve train is allocated to at least one cylinder.

4. The diesel internal combustion engine according to claim 1, wherein a compression ratio on a cylinder can be set variably.

5. The diesel internal combustion engine according to claim 1, wherein an adaptation of an injection pressure is provided as a function of the fuel characterization.

6. An operating mode of an internal combustion engine that is operated with a fuel mixture having a first and a second fuel, wherein the internal combustion engine operates at least predominantly according to the diesel principle, wherein a first control strategy performs external ignition in a lower load range and a second control strategy performs automatic ignition in a load range that is higher relative to the lower load range.

7. The operating mode according to claim 6, wherein the fuel mixture is characterized and a combustion-point control and a conversion rate are adapted to this mixture.

8. The operating mode according to claim 6, wherein a cylinder filling is set as a function of the characterization of the fuel mixture.

9. The operating mode according to claim 6, wherein for compensating the ignition delay and/or stabilization, a variable compression ratio is set on a cylinder, internal exhaust-gas recirculation is performed by means of a variable valve train and/or external exhaust-gas recirculation is performed.

10. The operating mode according to claim 7, wherein a variable compression ratio is set to at least 18 as a function of the characterization of the fuel.

11. The operating mode according to claim 7, wherein an injection pressure is reduced as a function of the characterization of the fuel.

12-14. (canceled)

15. The diesel internal combustion engine according to claim 1, wherein the fuel mixture has a cetane number less than 40 and a boiling point in the range of 90° C. and 200° C.

16. The operating mode according to claim 6, wherein the fuel mixture has a cetane number less than 40 and a boiling point in the range of 90° C. and 200° C.
